(19) United States
(12) Patent Application Publication
(10) Pub. No.: US 2026/0351917 A1
(43) Pub. Date: Nov. 5, 2026

(54) DEVICE FOR THERMOCOUPLE CONNECTOR REMOVAL

(71) Applicant: Rolls-Royce Corporation, Indianapolis, IN (US)

(72) Inventor: James E. Rardin, Indianapolis, IN (US)

(21) Appl. No.: 19/084,137

(22) Filed: Mar. 19, 2025

(51) Int. Cl. H01R 43/26; B25B 27/02; G01K 1/14; G01K 7/02

(52) U.S. Cl. CPC H01R 43/26; B25B 27/02; G01K 1/14; G01K 7/02

(57) ABSTRACT

A thermocouple connector removal device, the device comprising: a body comprising a first end configured to fit within a mounting hole of a thermocouple connector, wherein the thermocouple connector is inserted into a thermocouple receptacle device; a reaction post configured to contact the thermocouple receptacle device at a position proximate to the thermocouple connector; a first handle connected to the body; and a second handle connected to the reaction post, wherein displacement of the first handle towards the second handle presses the reaction post against the thermocouple receptacle device and causes the first end of the body to extract the thermocouple connector from the thermocouple receptacle device.

### TECHNICAL FIELD

This disclosure relates to electronic component removal.

### BACKGROUND

A thermocouple may generate a voltage that varies with temperature. A thermocouple receptacle device (e.g., a thermocouple scanner, thermocouple measuring device, etc.) may continuously measure the voltage and translate the voltage to a corresponding temperature measurement. In one example, the thermocouple may be connected to the thermocouple receptacle device via a thermocouple connector. It may be desirable to disconnect the thermocouple from the thermocouple measuring device.

### SUMMARY

In general, this disclosure describes a device for disconnecting a thermocouple from a thermocouple receptacle device (e.g., a thermocouple scanner, a thermocouple measuring device, etc.) by removing a thermocouple connector (TC) from the thermocouple receptacle device. A thermocouple may be made of two dissimilar metals (e.g., metal alloys chromel and alumel) and include a hot end and a cold end. The dissimilar metals may be joined at the hot end (e.g., probe, junction, etc.) and separated at the cold end. The area from the hot end to the cold end may be protected (e.g., contained, connected, etc.) by material and is referred to as the test lead. The dissimilar metals at the cold end may present a voltage that varies with temperature at the hot end. In one example, to measure the voltage across the cold ends a TC may be attached to each of the thermocouple's cold ends and be plugged (e.g., connected, mated, etc.) into a thermocouple receptacle device (herein, “receptacle”). The receptacle may output a temperature representative of the hot end of the thermocouple based on the voltage measured at the cold ends of the thermocouple. In some examples, after measurements are complete, one or more thermocouples may be disconnected from a receptacle.

Current techniques for disconnecting one or more thermocouples may be difficult, unpleasant, time consuming, and/or damaging. For instance, to disconnect a thermocouple from a receptacle, a TC of the thermocouple may be manually removed (e.g., without the assistance of a device). As one example, the TC may be gripped (e.g., with a hand) and then pulled from the receptacle. As another example, a test lead connected to the TC may be gripped and then pulled/yanked. Such techniques may assist in removing the TC from the receptacle and ultimately disconnecting the thermocouple from the receptacle. However, such techniques may present one or more disadvantages. As one example, attempting to fit a hand in such a way to grip the TC may be difficult due to the small size of the TC and tight space between multiple TCs. As another example, gripping and/or pulling the test lead may damage the thermocouple and/or result in separation of the test lead from the TC. As another example, pulling the TC from the receptacle may require an amount of force from the puller that is unpleasant (e.g., hurts the puller's hands and/or fingers). Further, considering these disadvantages, removal of multiple TCs may be unnecessarily time consuming.

In accordance with one or more aspects of this disclosure, a thermocouple connector removal device may enable removal of a TC with simple squeeze of a user's hand. For instance, a thermocouple connector removal device may include a first end, a reaction post, and two handles. The user may squeeze the handles, causing the reaction post to press against the receptacle resulting in the first end of the device extracting the TC from the receptacle. By using such a thermocouple connector removal device, an even and controlled force may be applied to remove the TC from the receptacle and thus disconnect the thermocouple from the receptacle without having to pull on the test lead or another sensitive area of the thermocouple. In this way, aspects of this disclosure may desirably reduce the difficultly, unpleasantness, time, and damage related to TC removal.

In one example, a thermocouple connector removal device, the device including: a body comprising a first end configured to fit within a mounting hole of a thermocouple connector, wherein the thermocouple connector is inserted into a thermocouple receptacle device; a reaction post configured to contact the thermocouple receptacle device at a position proximate to the thermocouple connector; a first handle connected to the body; and a second handle connected to the reaction post, wherein displacement of the first handle towards the second handle presses the reaction post against the thermocouple receptacle device and causes the first end of the body to extract the thermocouple connector from the thermocouple receptacle device.

In another example, a method including: inserting, a first end of a body of a thermocouple connector removal device into a mounting hole of a thermocouple connector, wherein the thermocouple connector is inserted into a thermocouple receptacle device, and wherein the thermocouple connector removal device comprises a reaction post configured to press against the thermocouple receptacle device at a position proximate to the thermocouple connector; and extracting, by displacing a first handle connected to the body towards a second handle connected to the reaction post and pressing the reaction post against the thermocouple receptacle device, the thermocouple connector from the thermocouple receptacle device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual diagram illustrating a first example of a thermocouple connector removal device in a first state, in accordance with one or more aspects of this disclosure.

FIG. 1B is a conceptual diagram illustrating a first example of a thermocouple connector removal device in a second state, in accordance with one or more aspects of this disclosure.

FIG. 1C is a conceptual diagram illustrating the example thermocouple connector of FIGS. 1A-1B in further detail, in accordance with one or more aspects of this disclosure.

FIG. 1D is a conceptual diagram illustrating the example thermocouple receptacle device of FIGS. 1A-1B in further detail, in accordance with one or more aspects of this disclosure.

FIG. 2A is a conceptual diagram illustrating a second example of a thermocouple connector removal device in a first state, in accordance with one or more aspects of this disclosure.

FIG. 2B is a conceptual diagram illustrating a second example of a thermocouple connector removal device in a second state, in accordance with one or more aspects of this disclosure.

FIG. 3 is a flowchart illustrating an example mode of operation of an example device that performs thermocouple connector removal, in accordance with one or more aspects of this disclosure

Like reference characters refer to like elements throughout the figures and description.

### DETAILED DESCRIPTION

In general, this disclosure describes a device for disconnecting a thermocouple from a receptacle device (e.g., a thermocouple scanner, a thermocouple measuring device, etc.) by removing a thermocouple connector (TC) from the thermocouple receptacle device (hereinafter, “receptacle”).

The connection between the TC and the receptacle may include tight engagement to ensure accurate measurements which may result in a high friction connection between the TC and the receptacle that is difficult to remove. Further, multiple thermocouples may be used simultaneously, such that multiple TCs are plugged in next to each other (e.g., close to each other) in the same receptacle. In one example, TCs may be miniaturized (e.g., a smaller version of the typical TC) to optimize the number of TCs that are connected to a receptacle. In some examples, after measurements are complete, one or more thermocouples may be disconnected from a receptacle.

Current techniques for disconnecting one or more thermocouples may be difficult, unpleasant, time consuming, and/or damaging. For instance, to disconnect a thermocouple from a receptacle, a TC of the thermocouple may be manually removed (e.g., without the assistance of a device). As one example, the TC may be gripped (e.g., with a hand) and then pulled from the receptacle. As another example, a test lead connected to the TC may be gripped and then pulled/yanked. Such techniques may assist in removing the TC from the receptacle and ultimately disconnecting the thermocouple from the receptacle. However, such techniques may present one or more disadvantages. As one example, attempting to fit a hand in such a way to grip the TC may be difficult due to the small size of the TC and tight space between multiple TCs. As another example, gripping and/or pulling the test lead may damage the thermocouple and/or result in separation of the test lead from the TC. As another example, pulling the TC from the receptacle may require an amount of force from the puller that is unpleasant (e.g., hurts the puller's hands and/or fingers). Further, considering these disadvantages removal of multiple TCs may be unnecessarily time consuming.

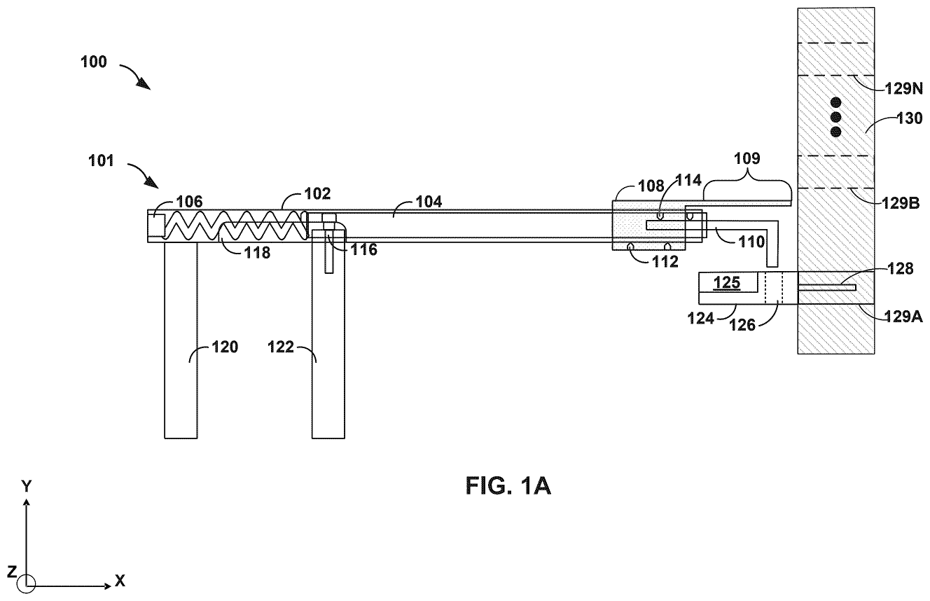

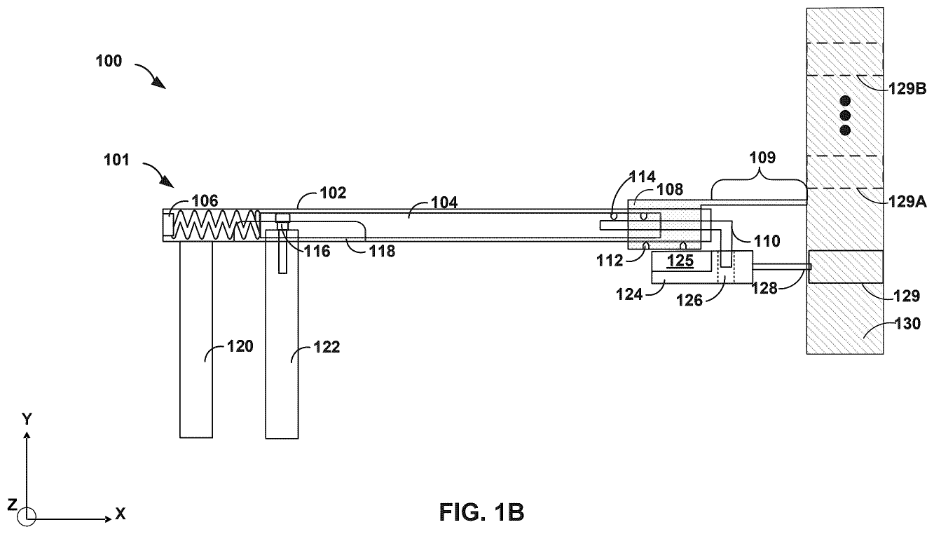

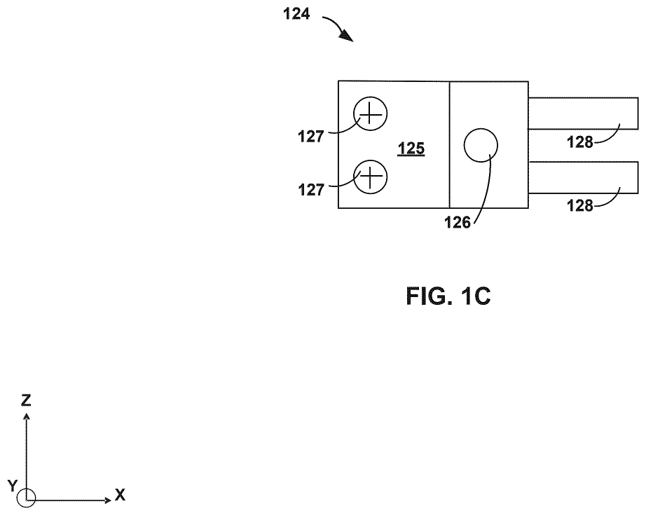

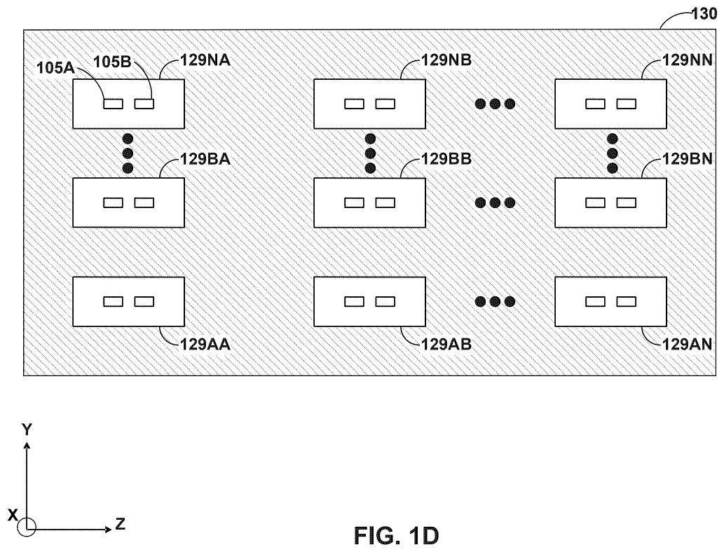

FIGS. 1A and 1B are conceptual diagrams illustrating an environment including a thermocouple connector removal device removing a thermocouple connector from a thermocouple receptable device, in accordance with one or more aspects of this disclosure. Environment 100 of FIGS. 1A and 1B may include thermocouple connector removal device 101 (herein, “device 101”), thermocouple connector 124 (herein, “TC 124”), and thermocouple receptacle device 130 (herein, “receptacle 130”). As illustrated by FIG. 1A, device 101 is in an extended state (e.g., a first state). As illustrated by FIG. 1B, device 101 is in a compressed state (e.g., a second state) in which device 101 is in the process of removing (e.g., has almost fully removed) TC 124 from receptacle 130.

A thermocouple may be made of two dissimilar metals (e.g., metal alloys chromel and alumel) and include a hot end and a cold end. The dissimilar metals may be joined at the hot end (e.g., probe, junction, etc.) and separated at the cold end. The area from the hot end to the cold end may be protected (e.g., contained, connected, etc.) by material and is referred to as the test lead. The dissimilar metals at the cold end may present a voltage that varies with temperature at the hot end.

In one example, the hot end may be subjected to the environment or object where the temperature is to be measured. For instance, the hot end may be stuck into a fire while the cold end is left at room temperature. The difference in temperature between the hot end and cold ends may cause an electron build up at the cold ends. However, because the thermocouple is made of two dissimilar metals the electron build up at the cold end of each of the dissimilar metals may be different. In this way, a voltage that varies with the temperature at the hot end of the thermocouple may be measured across the cold ends of the thermocouple.

In one example, to measure the voltage across the cold ends a TC may attach to each of the thermocouple's cold ends and be plugged (e.g., connected, mated, etc.) into receptacle 130. Receptacle 130 may output a temperature representative of the hot end of the thermocouple based on the voltage measured at the cold ends of the thermocouple.

In one example, receptacle 130 may be a thermocouple measuring device, a thermocouple scanner, a thermocouple and voltage measurement instrument, or any device configured to receive a corresponding connector for electrical connection. Receptacle 130 may include one or more channels 129A-129N (e.g., mating sockets, sockets, etc.) that are each designed to receive pins (e.g., prongs, a plug comprising one or more pins, leads, connectors, etc.). Channels 129A-129N (collectively, “channels 129”) of receptacle 130 may each be configured to measure pressure, strain, temperature, position, and voltage. Channels 129 may be configured with open transducer detection functionality to provide a continuous indication of the status of the respective channel. In one example, receptacle 130 may include three rows of channels 129A-129N. Each row may contain twenty-six individual channels. For instance, channel 129A may be one channel of twenty-six channels aligned horizontally along the Z axis. Device 101 may be configured to fit between rows of channels 129 as illustrated by the position of device 101 between channel 129A and channel 129B. In some examples, environment 100 may include multiple receptacles 130 (e.g., twenty receptacles).

TC 124 may include hole 126, portion 125, and pins 128. In some examples, hole 126 may be centered on a housing of TC 124. In some examples, portion 125 of TC 124 is distal from receptacle 130 and may be opened via removal (e.g., unscrewing) of one or more screws. Once opened, portion 125 may facilitate connection to a thermocouple. In one example, each cold end of a thermocouple may be connected to a corresponding terminal (e.g., contact) within portion 125, via a screw (e.g., clamping screw). Once the thermocouple is connected to TC 124, portion 125 may be closed. In one example, the material (e.g., metal alloys) of the terminals within portion 125 of TC 124 must match the material of each of the cold ends of the thermocouple.

In some examples, the housing of TC 124 may be made of plastic, or any high-temperature resistant material. TC 124 with a thermocouple connected may measure temperatures ranging from below zero degrees Fahrenheit to above two-thousand degrees Fahrenheit. TC 124 may be rectangular or circular in shape. In some examples, TC 124 may include one or more pins 128. In one example, pins 128 may be round or flat pins. While aspects of this disclosure are described with respect to receptacle 130 including channel 129A and TC 124 including pins128, aspects of this disclosure are not so limited. For instance, receptacle 130 may include pins while TC 124 includes a channel (e.g., a mating socket, socket, etc.).

Hole 126 may be configured for mounting or interlocking two TCs together semi-permanently. The inside of hole 126 may be textured, roughened, and/or smooth. In some examples, hole 126 may be configured to receive a screw or bolt for securing connector 124 to a panel or surface. In one example, hole 126 may be configured to provide strain relief.

TC 124 may be a miniaturized TC that may offer the same functionality and structure as a typical TC but in a more compact and space efficient form. In one example, a miniaturized TC may be half the size of a typical TC. While a miniaturized TC may offer the same functionality of a typical TC, miniaturized TCs may have additional benefits such as, portability, space efficiency, and reduced weight. In some examples, environment 100 may include seventy-eight TCs 124 installed (e.g., plugged into) receptacle 130. For instance, TCs 124 may be installed in three rows (e.g., in a strip configuration), with each row containing twenty-six TCs. In this example, it may desired or necessary for TCs 124 to be miniaturized.

Thermocouple connector removal device 101 may generally be operable to facilitate easy removal of TC 124 from receptacle 130. As shown in the example of FIGS. 1A-1C, thermocouple connector removal device 101 may include first handle 122, second handle 120, first body 104, second body 102, elastic component 106, hook 110, and reaction post 108.

Reaction post 108 may be connected to second body 102 via one or more screws 112 (e.g., set screws), such that reaction post 108 may be stationary relative to first body 104. In one example, reaction post 108 be configured to press (e.g., brace) against receptacle 130. Reaction post 108 may be able to press against receptacle 130 while device 101 is in an extended state or reaction post 108 may require device 101 to enter a compressed state in order for reaction post 108 to press against receptacle 130. In one example, reaction post 108 may be an L shaped structure with at least a portion 109 overhanging second body 102. In this way, second body 102 may not make direct contact with receptacle 130.

Reaction post 108 may be made of any type of material strong enough to brace against receptacle 130. In some examples, reaction post 108 may include a protectant cap that prevents reaction post 108 from damaging (e.g., scratching, denting, puncturing) receptacle 130 or TC 124. For instance, reaction post 108 may be made of steel with a rubber protectant cap.

Although illustrated in FIG. 1A as overhang 109 of reaction post 108 being located above (e.g., topmost, overhead, on top of, etc.) second body 102 in the Y direction, FIG. 1A is but one example and aspects of the disclosure are not so limited. For example, reaction post 108 may still be connected to second body 102 but oriented such that overhang 109 is located next to second body 102 along the Z axis. In one example, reaction post 108 may be connected to second body 102 but oriented in any direction such that reaction post 108 may press against receptacle 130.

Second body 102 may be an outer/external body (e.g., shell, shape, etc.) of device 101. In some examples, second body 102 may be made of plastic, stainless steel, or aluminum. First body 104 may be an inner/internal body (e.g., shell, surface, shape, etc.). In some examples, first body 104 may be made of a similar or different material relative to second body 102. For instance, first body 104 may be a push rod made of solid steel and second body 102 may be a hollow cylindrical shape made of steel. In one example, first body 104 may be configured to translate (e.g., move) within second body 102.

An end of first body 104, proximal to receptacle 130, may include an opening for inserting (e.g., connecting) and removing hook 110 from first body 104. In some examples, hook 110 may be connected to first body 104 by one or more screws 114 (e.g., set screws). Hook 110 may be any bent or curved device (e.g., a tool, material, structure, etc.) that is connected to first body 104. In some examples, hook 110 may be an L shaped hook. In one example, hook 110 may be a J shaped hook. In one example, hook 110 may be made of metal, steel, plastic, etc.

In one example, an end of hook 110 distal from first body 104 may be configured to fit within hole 126 of TC 124. In another example, an end of hook 110 distal from first body 104 may be configured to fit between TC 124 and receptacle 130. A user of device 101 may be able to switch between hooks. For instance, a user may be able to remove L shaped hook 110 from first body 104 and insert a J shaped hook into first body 104. In this way, device 101 may adapt to be compatible with a variety of TCs and receptacles. For instance, device 101 may be compatible with both TCs that include hole 126 and TCs that do not include hole 126.

Second body 102 may include cutout 118 (e.g., recess, slot, geometry, etc.) for movement of first handle 122. First handle 122 may be substantially perpendicular to second body 102. First handle 122 may be connected to first body 104 via a screw 116 (e.g., a cap screw). In some examples, first handle 122 may translate substantially parallel to second body 102 within cutout 118. In one example, when first handle 122 translates, first body 104 may also translate. Cutout 118 may serve as a boundary for first handle 122 and thus first body 104. For instance, first handle 122 may only translate as far to the left (along the X axis) as cutout 118 allows.

Second handle 120 may be substantially perpendicular to second body 102. In some examples, second handle 120 may be connected to second body 102 such that second handle 120 is stationary (e.g., does not translate). In one example, first handle 122 and second handle 120 may each be made of plastic or another material that is not conductive. In one example, the distance between first handle 122 and second handle 120 may change (e.g., fluctuate, not be constant, etc.), while the distance between first handle 122 and hook 110 may stay the same (e.g., constant). In the example illustrated by FIG. 1A, the distance between first handle 122 and second handle 120 may not increase but may decrease.

In one example, a first end of elastic component 106 may be adjacent to an end of first body 104 that is proximal to first handle 122 and a second end of elastic component 106 may be adjacent to an end of second body 102 that is proximal to second handle 120. In some examples, elastic component 106 may be a spring (e.g., a compression spring). Elastic component 106 may be configured to resist compressive force, such that elastic component 106 is compressed when force is applied and elastic component 106 returns to original length when the force is removed. In this way, elastic component 106 may be configured to generate a force pushing first handle 122 away from second handle 120. For instance, displacement of first handle 122 towards second handle 120 may compress (e.g., shorten, contract, etc.) elastic component 106. However, when first handle 122 is no longer displaced (e.g., first handle 122 returns to the position illustrated in FIG. 1A) elastic component 106 automatically returns to an original length (also illustrated in FIG. 1A).

In accordance with one or more aspects of this disclosure, device 101 may include, first handle 122, second handle 120, first body 104, second body 102, elastic component 106, hook 110, and reaction post 108 for TC removal. In one example, a user may squeeze handles 120 and 122 (e.g., displace first handle 122 towards second handle 120) causing the reaction post to press against receptacle 130 as first body 104 displaces towards second handle 120, thus extracting TC 124 from receptacle 130 via hook 110. By using device 101 an even and controlled force may be applied to remove TC 124 from receptacle 130 (e.g., the force may be applied in a consistent and uniform manner without sudden changes or fluctuations) and thus disconnect the thermocouple from receptacle 130 without having to pull on the test lead or another sensitive area of the thermocouple. In this way, aspects of this disclosure may desirably reduce the difficultly, unpleasantness, time, and damage related to TC removal.

For ease of understanding, aspects of this disclosure may be discussed with respect to removal of TC 124 from receptacle 130 or disconnecting a thermocouple from receptacle 130 by removal of TC 124. However, aspects of this disclosure are not so limited. For instance, aspects of this disclosure may be implemented in multiple ways to adapt to different electronic components. In one example, aspects of this disclosure may be applied to the removal of integrated circuits (e.g., operational amplifiers, microcontrollers, etc.) and/or other electronic components (e.g., resistors, capacitors, logic gates, etc.) from breadboards and/or printed circuit boards. In another example, aspects of this disclosure may be applied to the removal of AC and/or DC plugs from receptacles (e.g., unplugging a laptop plug from a household socket).

In one example, a user may insert hook 110 into hole 126 of TC 124. After inserting hook 110 into hole 126, a user may squeeze first handle 122 towards second handle 120 (e.g., displace/translate first handle 122 towards second handle 120). In some examples, second handle 120 is stationary relative to first handle 122, such that the user may pull (e.g., squeeze, move, etc.) first handle 122 towards second handle 120. In one example, device 101 may be configured to be operated by a single hand of a user, such that handles 120 and 122 may be squeezed by a single hand of the user to remove TC 124. For instance, a user may place their thumb on or around second handle 120 and one or more of their four fingers around first handle 122 and then squeeze their hand into a fist.

When the user squeezes and/or pulls handles 122 and 120, only first handle 122 may move, such that second handle 120 may provide the support/stability needed to move first handle 122. While squeezing first handle 122 towards second handle 120 the user may encounter some resistance from spring 106. As the user squeezes handles 122 and 120 together spring 106 may compress. As spring 106 compresses, the distance between handles 120 and 122 may decrease. However, the distance between first handle 122 and hook 110 may remain constant.

When first handle 122 translates so may first body 104 and thus hook 110. As the user begins to squeeze handles 122 and 120 to remove TC 124 from receptacle 130, the user may encounter resistance from the tight connection between receptacle 130 and TC 124. To oppose this resistance, reaction post 108 may provide a force opposite the movement of TC 124 by pressing against receptacle 130. The opposing force applied by reaction post 108 pressing against receptacle 130 may provide stability and leverage for device 101 to remove TC 124 from receptacle 130 despite the tight connection between TC 124 and receptacle 130. This opposing force applied by reaction post 108 may be substantially (e.g., plus or minus 10%) normal (e.g., perpendicular) relative to receptacle 130, such that lateral or angular forces may not be applied to TC 124 (e.g., no side loads are applied to TC 124). Applying a stable, consistent, and normal force to remove TC 124 may prevent damage to TC 124 or associated components (e.g., receptacle 130, a thermocouple, and/or a thermocouple test lead).

As the user continues to decrease the distance between handles 122 and 120, hook 110 (e.g., that is inserted in TC 124) may move further away from receptacle 130 and pull TC 124 out of receptacle 130. With hook 110 inserted in hole 126 the force of removing TC 124 is mostly concentrated to hole 126. Hole 126 may be configured to withstand the force of removal, whereas other areas of TC 124 or components connected to TC 124 (e.g., thermocouple test lead) may not be configured to withstand the force of removal.

Use of device 101 may completely or partially remove TC 124 from receptacle 130. As one example, device 101 may remove TC 124 completely, such that TC 124 is no longer making contact with receptacle 130. As another example, device 101 may mostly (e.g., almost, 90%, basically, etc.) remove TC 124 from receptacle 130. In some examples, portion 109 of reaction post 108 and/or the portion of hook 110 parallel to portion 109 of reaction post 108 may be configured (e.g., increased, decreased, shortened, lengthened, etc.) for either complete or partial removal of TC 124 from receptacle 130. For example, to partially remove TC 124 from receptacle 130 the length of portion 109 of reaction post 108 and the length of the portion of hook 110 parallel to portion 109 may each be decreased.

In some examples, hook 110 may include magnetic materials. For instance, hook 110 may include a magnetic material that attracts to a corresponding magnetic material within hole 126, such that after removal of TC 124 from receptacle 130 the user may manually have to detach TC 124 from hook 110. This manual detachment may be easy, simple, and quick. In other examples, hook 110 may be configured so that after removal of TC 124 from receptacle 130, TC 124 may automatically detach (e.g., fall) from hook 110.

After removal of TC 124 from receptacle 130, spring 106 may automatically reset the state of device 101. For instance, after removal of TC 124 from receptacle 130 a user may release the pressure keeping handles 120 and 122 (e.g., no longer squeeze handles 120 and 122) together which may cause spring 106 to decompress (e.g., device 101 may return to an extended state). This automatic reset of spring 106 may increase convenience when removing multiple TCs. For example, a user may be able to remove a first TC from a receptacle, release pressure on handles 120 and 122, and then remove a second TC from the same or a different receptacle.

As can be seen, device 101 may be advantageous for removal of TC 124 from receptacle 130. Device 101 may remove TC 124 from receptacle 130 without having to pull on the test lead or another sensitive area of the thermocouple or TC 124. Device 101 may reset after each use, be adaptable to a variety of TCs, and be configured to operate in tight spaces. In this way, aspects of this disclosure may desirably reduce the difficultly, unpleasantness, time, and damage that may occur during TC removal.

FIG. 1C is a conceptual diagram illustrating example thermocouple connector 124 of FIGS. 1A-1B in further detail, in accordance with one or more aspects of this disclosure. TC 124 of FIG. 1C may be an example of TC 124 of FIG. 1A or FIG. 1B. FIG. 1C illustrates TC 124 in a top view looking down at the X-Z plane.

TC 124 may include hole 126, portion 125, and plug (e.g., pins) 128. TC 124 may be a miniaturized TC that may offer the same functionality and structure as a typical TC but in a more compact and space efficient form. In the example illustrated by FIG. 1C, pins 128 are flat and/or square pins. In some examples, pins 128 may be round pins. In some examples, hole 126 may be located along an X axis centered relative to TC 124.

In some examples, portion 125 of TC 124 is distal from pins 128 and may be opened via removal (e.g., unscrewing) of one or more screws 127. Once opened, portion 125 may facilitate connection to a thermocouple. In one example, each cold end of a thermocouple may be connected to a corresponding terminal (e.g., contact) within portion 125 via a screw (e.g., a clamping screw). Once the thermocouple is connected to TC 124, portion 125 may be closed (as illustrated by FIG. 1C).

Hole 126 may be configured for mounting or interlocking two TCs together semi-permanently. The inside of hole 126 may be textured, rough, and/or smooth. In some examples, hole 126 may be configured to receive hook 110 and/or a screw or bolt for securing connector 124 to a panel or surface. In one example, hole 126 may be configured to provide strain relief.

FIG. 1D is a conceptual diagram illustrating the example thermocouple receptacle device 130 of FIGS. 1A-1B in further detail, in accordance with one or more aspects of this disclosure. Receptacle 130 of FIG. 1D may be an example of receptacle 130 of FIG. 1A or FIG. 1B. FIG. 1D illustrates receptacle 130 in a straight on view looking at the Y-Z plane. In some examples, receptacle 130 may include three rows of channels 129AA-129NN (collectively, “channels 129”), with each of channels 129 including slot 105A and slot 105B (collectively, “slots 105”). Channels 129 of FIG. 1D may be an example of channels 129 of FIG. 1A or FIG. 1B.

In some examples, slots 105 may be configured to receive pins 128 to form a connection between TC 124 and receptacle 130. Slots 105 may be configured to match the shape of pins 128. In the example illustrated by FIG. 1D, slots 105 may be flat and/or square shaped to match the flat and/or square shape of pins 128. In some examples, slots 105 may be round shaped. Further, slots 105 may include more or less than two slots. In one example, slots 105 may include one slot. In another example, slots 105 may include three slots.

In one example, a first row of channels 129 may include channel 129AA, channel 129AB, and channel 129AN, a second row of channels 129 may include channel 129BA, channel 129BB, and channel 129BN, and a third tow of channels 129 may include channel 129NA, channel 129NB, and channel 129NN. As illustrated in FIG. 1D channels 129AN, 129BN, and 129NN each represent an “nth” channel (e.g., along the Z axis) in the first, second, or third row of channels 129, respectively. In this way, each row of channels 129 may be configured to include any desirable amount of channels. In one example, each row of channels 129 may include twenty-six individual channels, such that the last channel in the first row may be 129AZ, the last channel in the second row may be 129BZ, and the last channel in the third row may be 129NZ.

As further illustrated in FIG. 1D channels 129NA, 129NB, and 129NN each represent an “nth” channel (e.g., along the Y axis) in the first, second, or third column of channels 129, respectively. In this way, each column of channels 129 may be configured to include any desirable amount of channels. In one example, each column of channels 129 may include four individual channels, such that the last channel in the first column may be 129DA, the last channel in the second column may be 129DB, and the last channel in the third column may be 129DN. In this way receptacle 130 would include four rows.

While FIG. 1D illustrates receptacle 130 as being configurable to increase the number of channels 129, the disclosure is not so limited. Receptacle 130 may be configured to reduce the number of channels 129. For instance, receptacle 130 may be configured to only include channel 129AA. In this way, receptacle 130 may be configured to include any number of channels 129.

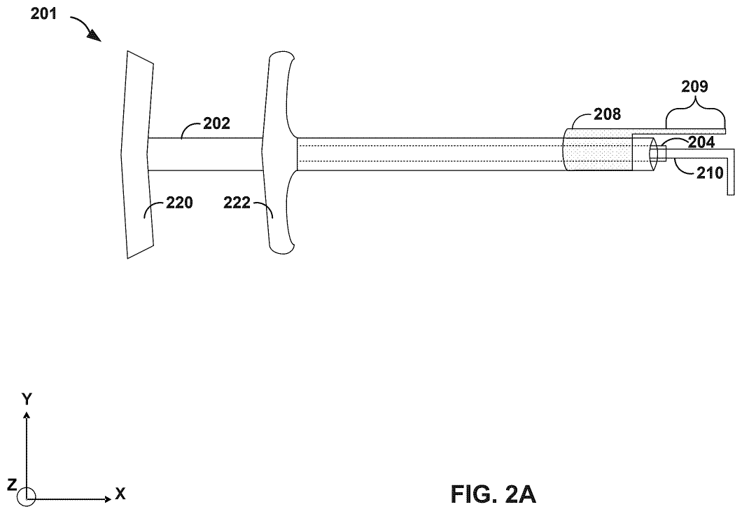

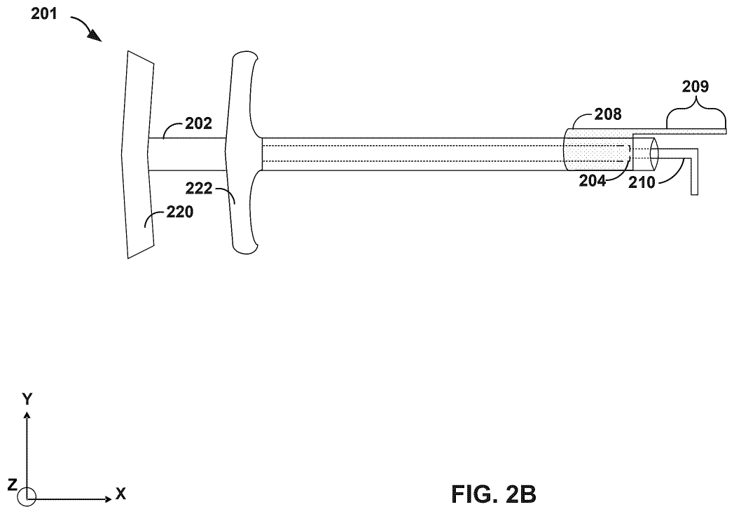

FIGS. 2A and 2B are conceptual diagrams illustrating a second example of thermocouple connector removal device 201, in accordance with one or more aspects of this disclosure. Thermocouple connector removal device 201 (herein, “device 201”) may be an example of thermocouple connector removal device 101 of FIG. 1A and FIG. 1B. Device 201 may include first handle 222, second handle 220, first body 204, second body 202, hook 210, and reaction post 208. First handle 222, second handle 220, first body 204, second body 202, hook 210, and reaction post 208 may be examples of first handle 122, second handle 120, first body 104, second body 102, hook 110, and reaction post 108 of FIG. 1A or FIG. 1B. As illustrated by FIG. 2A, device 201 is in an extended state (e.g., a first state). As illustrated by FIG. 2B, device 201 is in a compressed state (e.g., a second state) where, for example, device 201 may be in the process of removing (e.g., has almost fully removed) a TC from a receptacle.

In accordance with one or more aspects of this disclosure, device 201 may operate substantially similar to device 101. Device 201 may demonstrate an alternative design of device 101 which does not substantially change the functionality or intended use of device 101. For instance, handles 220 and 222 may be structured and positioned differently than handles 120 and 122 but may still function to control removal of a TC from a receptacle.

In one example, device 201 may be configured to be operated by a single hand of a user, such that handles 220 and 222 may be squeezed by a single hand of the user to remove a TC. For instance, a user may place the palm and/or thumb of their hand on or around second handle 220 and one or more of their four fingers around first handle 222. When the user squeezes handles 222 and 220, only first handle 222 may move, such that second handle 220 may provide support/stability to move first handle 222. Squeezing handles 222 and 220 may involve a motion similar to a user squeezing their hand into a fist.

By squeezing handles 222 and 220 together, the user may reduce the distance between handles 222 and 220 and between second handle 220 and hook 210. In some examples, hook 210 may be inserted into a TC. In this way, by squeezing handles 222 and 220 together, hook 210 is pulled (and thus the TC is pulled) towards second handle 220 while reaction post 208 may be pressed against the receptacle. Thus, the user may use device 201 similarly to device 101 to remove the TC from the receptacle.

In accordance with one or more aspects of this disclosure, device 201 may remove a TC from a receptacle. For instance, by inserting hook 210 into a mounting hole of the TC or the space between the TC and the receptacle, squeezing handles 220 and 222 together, and pressing reaction post 208 against the receptacle, device 201 is able to remove the TC from the receptacle without having to pull on the test lead or another sensitive area of the thermocouple or TC. Device 201 may include various designs (e.g., different handle designs), may reset after each use, be adaptable to a variety of TCs, and be configured to operate in tight spaces. In this way, aspects of this disclosure may desirably reduce the difficultly, unpleasantness, time, and damage that occurs during TC removal.

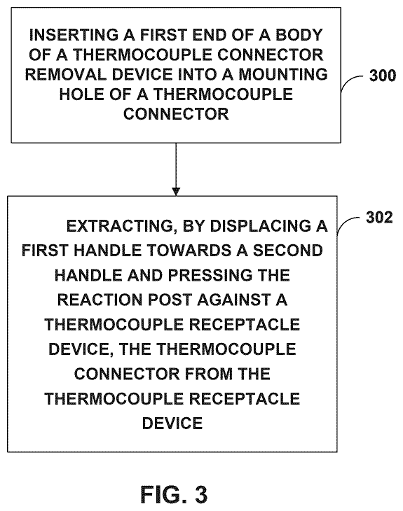

FIG. 3 is a flowchart illustrating an example mode of operation of an example device that performs thermocouple connector removal, in accordance with one or more aspects of this disclosure. Although the example operation of FIG. 3 is described as being performed by device 101 of FIG. 1A-1B, in other examples some or all of the example operations may be performed by another device (e.g., device 201 of FIG. 2).

A thermocouple may generate a voltage that varies with temperature. A thermocouple receptacle device (e.g., a thermocouple scanner, a thermocouple measuring device, etc.) may continuously measure the voltage generated by the thermocouple and translate the voltage to a corresponding temperature measurement. In one example, the thermocouple may be connected to the receptacle via a TC. In some examples, device 101 may assist in removal of a TC from a receptacle.

A user may insert a first end of body 104 (e.g., first body 104) of device 101 into mounting hole 126 of TC 124 that may be currently inserted within receptacle device 130 (300). First body 104 may include hook 110 that may be configured to fit within hole 126. Device 101 may include reaction post 108 that is configured to press against receptacle device 130 at a position proximate to TC 124. In some examples, first body 104 may be configured to translate within second body 102. First handle 122 may be connected and substantially perpendicular to first body 104. Second handle 120 may be substantially perpendicular to second body 102 and connected to reaction post 108 via second body 102.

In some examples, a user may extract, by displacing first handle 122 towards second handle 120 and pressing reaction post 108 against receptacle 130, TC 124 from receptacle device 130 (302). First handle 122 and second handle 120 may be collectively configured to be squeezed by a single hand of a user to extract TC 124. In some examples, TC 124 may be a miniaturized TC.

In one example, device 101 may include elastic component 106. Displacement of first handle 122 towards second handle 120 may compress elastic component 106. The distance between first handle 122 and hook 110 may remain constant as first handle 122 moves relative to second handle 120.

Elastic component 106 may be configured to generate a force pushing first handle 122 away from second handle 120. For instance, after squeezing handles 120 and 122 together to extract TC 124 the user may release handles 120 and 122 and elastic component 106 may push handles 120 and 122 apart. In this way, device 101 may reset (e.g., return to a steady state where there is no force being applied to compress elastic component 106) after each extraction of a TC. In one example, elastic component 106 may be a spring.

The following examples may illustrate one or more aspects of the disclosure:
Example 1. A thermocouple connector removal device, the device comprising: a body comprising a first end configured to fit within a mounting hole of a thermocouple connector, wherein the thermocouple connector is inserted into a thermocouple receptacle device; a reaction post configured to contact the thermocouple receptacle device at a position proximate to the thermocouple connector; a first handle connected to the body; and a second handle connected to the reaction post, wherein displacement of the first handle towards the second handle presses the reaction post against the thermocouple receptacle device and causes the first end of the body to extract the thermocouple connector from the thermocouple receptacle device.
Example 2. The device of example 1 further comprising an elastic component configured to generate a force pushing the first handle away from the second handle.
Example 3. The device of example 2, wherein the elastic component comprises a spring.
Example 4. The device of example 3, wherein displacement of the first handle towards the second handle compresses the spring.
Example 5. The device of any of examples 1-4, wherein the first end of the body comprises a hook configured to fit within the mounting hole.
Example 6. The device of example 5, wherein a distance between the first handle and the hook remains constant as the first handle moves relative to the second handle.
Example 7. The device of any of examples 1-6, wherein the first handle is substantially perpendicular to the body, and wherein the second handle is substantially perpendicular to the body.
Example 8. The device of any of examples, 1-7, wherein the thermocouple connector is a miniaturized thermocouple connector.
Example 9. The device of any of examples 1-8, wherein the body is a first body, wherein the second handle is connected to the reaction post via a second body, and wherein the first body is configured to translate within the second body.
Example 10. The device of any of examples 1-9, wherein the first handle and the second handle are collectively configured to be squeezed by a single hand of a user to extract the thermocouple connector.
Example 11. A method comprising: inserting, a first end of a body of a thermocouple connector removal device into a mounting hole of a thermocouple connector, wherein the thermocouple connector is inserted into a thermocouple receptacle device, and wherein the thermocouple connector removal device comprises a reaction post configured to press against the thermocouple receptacle device at a position proximate to the thermocouple connector; and extracting, by displacing a first handle connected to the body towards a second handle connected to the reaction post and pressing the reaction post against the thermocouple receptacle device, the thermocouple connector from the thermocouple receptacle device.
Example 12. The method of example 11, further comprising an elastic component configured to generate a force pushing the first handle away from the second handle.
Example 13. The method of example 12, wherein the elastic component comprises a spring.
Example 14. The method of example 13, wherein displacing of the first handle towards the second handle compresses the spring.
Example 15. The method of any of examples 11-14, wherein the first end of the body comprises a hook configured to fit within the mounting hole.
Example 16. The method of example 15, wherein a distance between the first handle and the hook remains constant as the first handle moves relative to the second handle.
Example 17. The method of any of examples 11-16, wherein the first handle is substantially perpendicular to the body, and wherein the second handle is substantially perpendicular to the body.
Example 18. The method of any of examples 11-17, wherein the thermocouple connector is a miniaturized thermocouple connector.
Example 19. The method of any of examples 11-18, wherein the body is a first body, wherein the second handle is connected to the reaction post via a second body, and wherein the first body is configured to translate within the second body.
Example 20. The method of any of examples 11-19, wherein the first handle and the second handle are collectively configured to be squeezed by a single hand of a user to extract the thermocouple connector.

Various examples have been described. These and other examples are within the scope of the following claims.

What is claimed is:

1. A thermocouple connector removal device, the device comprising:
a body comprising a first end configured to fit within a mounting hole of a thermocouple connector, wherein the thermocouple connector is inserted into a thermocouple receptacle device;
a reaction post configured to contact the thermocouple receptacle device at a position proximate to the thermocouple connector;
a first handle connected to the body; and
a second handle connected to the reaction post, wherein displacement of the first handle towards the second handle presses the reaction post against the thermocouple receptacle device and causes the first end of the body to extract the thermocouple connector from the thermocouple receptacle device.

2. The device of claim 1 further comprising an elastic component configured to generate a force pushing the first handle away from the second handle.

3. The device of claim 2, wherein the elastic component comprises a spring.

4. The device of claim 3, wherein displacement of the first handle towards the second handle compresses the spring.

5. The device of claim 1, wherein the first end of the body comprises a hook configured to fit within the mounting hole.

6. The device of claim 5, wherein a distance between the first handle and the hook remains constant as the first handle moves relative to the second handle.

7. The device of claim 1, wherein the first handle is substantially perpendicular to the body, and wherein the second handle is substantially perpendicular to the body.

8. The device of claim 1, wherein the thermocouple connector is a miniaturized thermocouple connector.

9. The device of claim 1, wherein the body is a first body, wherein the second handle is connected to the reaction post via a second body, and wherein the first body is configured to translate within the second body.

10. The device of claim 1, wherein the first handle and the second handle are collectively configured to be squeezed by a single hand of a user to extract the thermocouple connector.

11. A method comprising:
inserting, a first end of a body of a thermocouple connector removal device into a mounting hole of a thermocouple connector, wherein the thermocouple connector is inserted into a thermocouple receptacle device, and wherein the thermocouple connector removal device comprises a reaction post configured to press against the thermocouple receptacle device at a position proximate to the thermocouple connector; and
extracting, by displacing a first handle connected to the body towards a second handle connected to the reaction post and pressing the reaction post against the thermocouple receptacle device, the thermocouple connector from the thermocouple receptacle device.

12. The method of claim 11 further comprising an elastic component configured to generate a force pushing the first handle away from the second handle.

13. The method of claim 12, wherein the elastic component comprises a spring.

14. The method of claim 13, wherein displacing of the first handle towards the second handle compresses the spring.

15. The method of claim 11, wherein the first end of the body comprises a hook configured to fit within the mounting hole.

16. The method of claim 15, wherein a distance between the first handle and the hook remains constant as the first handle moves relative to the second handle.

17. The method of claim 11, wherein the first handle is substantially perpendicular to the body, and wherein the second handle is substantially perpendicular to the body.

18. The method of claim 11, wherein the thermocouple connector is a miniaturized thermocouple connector.

19. The method of claim 11, wherein the body is a first body, wherein the second handle is connected to the reaction post via a second body, and wherein the first body is configured to translate within the second body.

20. The method of claim 11, wherein the first handle and the second handle are collectively configured to be squeezed by a single hand of a user to extract the thermocouple connector.
